(19) United States
(12) Patent Application Publication
(10) Pub. No.: US 2023/0109995 A1
(43) Pub. Date: Apr. 13, 2023

(54) UNMANNED AERIAL VEHICLE DETECTOR

(71) Applicant: Airspeed Electronics Ltd., Biggleswade (GB)

(72) Inventor: Benjamin James Cook, Biggleswade (GB)

(73) Assignee: Airspeed Electronics Ltd., Biggleswade (GB)

(21) Appl. No.: 17/836,641

(22) Filed: Jun. 9, 2022

(30) Foreign Application Priority Data
Jun. 9, 2021 (GB) 2108243.3

(51) Int. Cl. G01S 5/22; G01S 5/20

(52) U.S. Cl. CPC G01S 5/22; G01S 5/20; G01S 2205/03

(57) ABSTRACT

Method of detecting and tracking an unmanned aerial vehicle, the method comprising, at a detector unit (300a) comprising a first microphone and a second microphone: monitoring for a sound associated with the presence of the unmanned aerial vehicle (505) in the vicinity of the detector unit; in response to the monitoring indicating the presence of the unmanned aerial vehicle, determining, at the detector unit, a phase delay between the sound as received at the first microphone and the sound as received at the second microphone; on the basis of the determined phase delay and a known separation of the first microphone and the second microphone, determining, at the detector unit, an azimuth angle (507a) to the unmanned aerial vehicle from the detector unit; and transmitting, to a computing node (501), the determined azimuth angle for use in determining a location of the unmanned aerial vehicle.

### TECHNICAL FIELD

The present invention concerns acoustic detection and tracking of unmanned aerial vehicles. The invention also concerns a system for detecting and tracking unmanned aerial vehicles using a plurality of dispersed detector units.

### BACKGROUND

The proliferation of small, inexpensive, and commercially available drones (also known as unmanned air vehicles or unmanned air systems) presents a new risk to critical infrastructure. The low-cost and increased accessibility of such drones increases the risk of drones being operated (intentionally or otherwise) in ways which pose a danger to the safety and security of critical infrastructure (such as airports and passenger aircraft). In the hands of a hostile actor, such drones can be deliberately used to disrupt or deny services (for example, by flying over airfields or through other controlled airspace), or even to initiate direct attacks (for example, through weaponisation of the drone). There is therefore a need for systems to defend sensitive installations and infrastructure from incursions by such low-cost drones.

Traditional air defence systems are typically optimised for detecting and tracking large, fast-moving, manned aircraft flying at high altitudes. Such systems typically operate using RADAR sensors. Due to the small physical size of low-cost commercial drones and the use of RF transparent materials in their construction (for example, plastic), RADAR sensors can have difficulties detecting and tracking such drones. Whilst this can be overcome by the use of high frequencies (for example, >7 GHz), radio waves at such high frequencies are attenuated by rain, fog, and smoke, limiting the effective range of the sensor. In addition, objects (for example, trees and buildings) can also generate clutter in a reflected RADAR signal, which can mask a small, low flying drone.

The use of electro-optic (EO) sensors (for example, visible light or infra-red cameras) has been proposed to address these problems, but such sensors are affected by atmospheric conditions and ambient light levels. Systems have also been proposed which use radiated telemetry emissions from the drone or a pilot of the drone to locate the target drone. However, advances in autonomous control of drones, which allow a drone to operate in ‘radio silence’, may also soon render such sensors obsolete.

Thus, the sensing technologies used in such prior art counter drone systems include a number of vulnerabilities, which an aggressor could choose to exploit (for example, by flying at very low level, through ‘urban canyons’, or at night).

In an attempt to overcome these vulnerabilities, it has been proposed to use (either alone or in combination with one or more other sensing technologies as discussed above) acoustic detection and tracking methods. Acoustic detection and tracking of a drone is only possible at limited ranges (for example, of up to approximately 300 m for a 1.3 kg drone). Therefore, to fully protect a large installation (for example, an airport), it would be necessary to deploy a large number of acoustic detectors. However, for such prior art systems, a wide-area deployment is usually technically impractical and/or prohibitively expensive.

The present invention seeks to mitigate the above-mentioned problems. Alternatively or additionally, the present invention seeks to provide improved means for detecting and tracking unmanned aerial vehicles.

### SUMMARY

The present invention provides, according to a first aspect, a method of detecting and tracking an unmanned aerial vehicle, the method comprising, at a detector unit comprising a first microphone and a second microphone:

monitoring for a sound associated with the presence of the unmanned aerial vehicle in the vicinity of the detector unit:

in response to the monitoring indicating the presence of the unmanned aerial vehicle, determining, at the detector unit, a phase delay between the sound as received at the first microphone and the sound as received at the second microphone;

on the basis of the determined phase delay and a known separation of the first microphone and the second microphone, determining, at the detector unit, an azimuth angle to the unmanned aerial vehicle from the detector unit; and

transmitting, to a computing node, the determined azimuth angle for use in determining a location of the unmanned aerial vehicle.

Methods according to embodiments of the invention provide an acoustic unmanned aerial vehicle (UAV) detection system in which the processing functions required to determine the phase delay and the azimuth angle to a detected UAV are performed at the detector unit. By performing these functions at the detector unit, the UAV detection system forms a decentralised processing system. Thus, in a UAV detection system covering a given detection area, the computation required to detect and track UAVs within that detection area is performed at multiple dispersed computing resources. This provides a UAV detection system which is readily and easily scalable to provide UAV detection across detection areas of a range of sizes. When utilising a UAV detection system according to embodiments of the invention, the detection area can be expanded or adapted simply by deploying additional detector units. There is no need to upgrade or adapt a centralised computing resource in order to process data from the new detector units, as the newly required processing is dispersed to those new detector units.

As discussed, prior art UAV detection systems are typically constrained in the scale at which they can be deployed. That is at least in part due to the requirement for transmission of large amounts of raw data to a centralised processing node. The decentralised processing system provided in the UAV detection system of the invention overcomes this constraint by removing the need to transmit raw data to the computing node. Instead, the raw data is processed locally at the detector unit, and only small amounts of data indicating the determined azimuth angles of detected UAVs need to be transmitted to the computing node. Thus, UAV detection systems according to embodiments of the invention can also be deployed on a large scale, in practice unrestrained by limited bandwidth of datalinks connecting the detector unit to the computing node.

According to a second aspect of the invention, there is also provided a computer program comprising a set of instructions, which, when executed by a computer, cause the computer to perform a method according to the first aspect.

According to a third aspect of the invention, there is also provided a detector unit for detecting and tracking an unmanned aerial vehicle, the detector unit comprising:

a first microphone;

a second microphone;

a signal processing module configured to:

monitor for a sound associated with the presence of the unmanned aerial vehicle in the vicinity of the detector unit,

in response to the monitoring indicating the presence of the unmanned aerial vehicle, determine a phase delay between the sound as received at the first microphone and the sound as received at the second microphone, and

on the basis of the determined phase delay and a known separation of the first microphone and the second microphone, determine an azimuth angle to the unmanned aerial vehicle from the detector unit; and

a transmitter module configured to transmit, to a computing node, the determined azimuth angle for use in determining a location of the unmanned aerial vehicle.

According to a fourth aspect of the invention, there is provided a system for detecting and tracking an unmanned aerial vehicle, the system comprising:

a plurality of detection units according to the third aspect; and

a computing node configured to:
receive, from a first detection unit in the plurality, a first azimuth angle from the first detection unit to the unmanned aerial vehicle;
receive, from a second detection unit in the plurality, a second azimuth angle from the second detection unit to the unmanned aerial vehicle; and
determine, on the basis of the first azimuth angle, the second azimuth angle, and known locations of the first detection unit and the second detection unit, a ground location of the unmanned aerial vehicle.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic view of a detector unit according to a first embodiment of the invention;

FIG. 2 shows a functional block diagram of the detector unit of FIG. 1;

FIG. 3a shows a schematic view of a detector unit according to a second embodiment of the invention:

FIG. 3b shows a perspective view of the detector unit of FIG. 3a;

FIG. 3c shows a functional block diagram of the detector unit of FIGS. 3a and 3b;

FIG. 4a shows a schematic view of a detector unit according to a third embodiment of the invention;

FIG. 4b shows a perspective view of the detector unit of FIG. 4a;

FIG. 5 shows a schematic view of a system according to a fourth embodiment of the invention

FIG. 6 shows a schematic view of the computing node of FIG. 5; and

FIG. 7 shows a flow chart illustrating a method according to a fifth embodiment of the invention.

### DETAILED DESCRIPTION

The first aspect of the invention provides a method of detecting and tracking an unmanned aerial vehicle. The method comprises, at a detector unit comprising a first microphone and a second microphone: monitoring for a sound associated with the presence of the unmanned aerial vehicle in the vicinity of the detector unit; in response to the monitoring indicating the presence of the unmanned aerial vehicle, determining, at the detector unit, a phase delay between the sound as received at the first microphone and the sound as received at the second microphone; on the basis of the determined phase delay and a known separation of the first microphone and the second microphone, determining, at the detector unit, an azimuth angle to the unmanned aerial vehicle from the detector unit; and transmitting, to a computing node, the determined azimuth angle for use in determining a location of the unmanned aerial vehicle.

The first microphone and the second microphone can be said to together form a microphone array. Where a detector unit comprises one or more additional microphones, those microphones can also be said to form part of the microphone array.

It may be that the first microphone and the second microphone are each mounted in outwards (for example, forwards) facing surface of the detector unit. It may be that the first microphone and the second microphone both are uni-directional microphones and are mounted in the surface so as to be sensitive to sound received from the front of the detector unit and to reject sound from the rear of the detector unit. It will be appreciated that, in this context, the front of the detector unit refers to a direction in which the detector unit is intended to monitor for unmanned aerial vehicles.

It will be appreciated that a phase delay arises between a sound as received at the first microphone and at the second microphone due their being spaced apart from one another. For any given sound, one of the two microphones will receive a delayed version of the sound compared to that received by the other. The magnitude of the delay and the order in which the two microphones receive the sound is determined by the position of the noise source in relation to the detector unit. This delay manifests itself as a phase delay between the sounds as received at the first microphone and the second microphone.

It may be that the first microphone and second microphone are arranged such that, in use, they are positioned at substantially the same height. The first microphone and the second microphone may be spaced apart from one another. The first microphone and the second microphone may be spaced apart by between 5 cm and 100 cm, preferably 10 cm and 90 cm, more preferably 25 cm and 75 cm, yet more preferably between 40 cm and 60 cm.

Where the first microphone and the second microphone are arranged such that, in use, they are at the substantially the same height, any phase delay determined between a sound as received at the first microphone and the second microphone can be attributed solely to an azimuthal position of the unmanned aerial vehicle. There is thus no need for a calculation of the horizontal component from the determined phase delay. Thus, the computation of the azimuth angle is simplified and requires less computing power, facilitating the performance of the computation at the detector unit, rather than in a large centralised computing resource. Thus, the simplification of the processing facilitates the use of a decentralised computing system, and thereby also the scalability of the UAV detection system of the invention.

It may be that the determining of the phase delay is performed on the basis of sound as received at only two microphones (for example, the first microphone and the second microphone).

Providing a sensor pair comprising only two microphones simplifies the processing required in order to determine the phase delay and the azimuth angle. This simplification reduces the computing power required to detect and determine an azimuth angle of an unmanned aerial vehicle, facilitating the performance of the required processing at the detector unit, rather than in a large centralised computing resource. Thus, the simplification of the processing facilitates the use of a decentralised computing system, and thereby also the scalability of the UAV detection system of the invention.

It may be that the first microphone and the second microphone together comprise a sensor pair. It may be that the first microphone and the second microphone together comprise a sensor pair having a field of view of less than 180°. It will be appreciated that, in this context, the “field of view” of the sensor pair refers to a sector, extending outwards from the sensor pair (and the detector unit), defining a region in which noise sources can be detected by the sensor pair. Such a sector can be defined by an angle subtending from an apex located equidistant between the two microphones in the sensor pair. The detector unit may comprise a further sensor pair. The sensor pair and the further sensor pair may be arranged such that the sensor pair and the further sensor pair together provide a field of view of greater than 140°, preferably greater than 1800, more preferably greaterthan 240°, yet more preferably greater than 300°. It may be that the detector unit comprises three or more sensor pairs. It may be that the three or more sensor pairs are arranged to together provide a 360° field of view. Where the detector unit comprises more than one sensor pair, it may be that each of the sensor pairs is arranged to face in a different direction. It may be that the detector unit comprises no more than twelve sensor pairs, preferably no more than eight sensor pairs, more preferably no more than six sensor pairs, yet more preferably no more than four sensor pairs. The detector unit may comprise only a single sensor pair. The detector unit may comprise three sensor pairs. In such cases, the sensor pairs may be arranged such that a direction faced by each of the three sensor pairs is offset from the directions faced by the other two sensor pairs by 120°. The detector unit may comprise four sensor pairs. In such cases, the sensor pairs may be arranged such that a direction faced by each of the four sensor pairs is offset from the directions faced by the adjacent sensor pairs by 90°. It may be that the detector unit comprises multiple faces, each of the multiple faces comprising a single sensor pair. In such cases, those face may be substantially vertical. Thus, it may be that the detector unit comprises three faces (for example, substantially vertical faces), each of the three faces comprising a single sensor pair (for example, such that the detector unit is shaped substantially as an equilateral triangle in plan view). It may be that the detector unit comprises four faces (for example, substantially vertical faces), each of the four faces comprising a single sensor pair (for example, such that the detector unit is substantially square in shape in plan view). It will be appreciated that, in such cases, the detector unit may comprises one or more further faces not having a sensor pair. Although the faces have been said to be substantially vertical, it will be appreciated by the skilled person that the faces may also be offset from vertical so as to be angled to face partially upwards.

It may be that detector unit comprises a first sensor pair, comprising the first microphone and the second microphone. The first sensor pair may be mounted on a first face of the detector unit. The first sensor pair may provide a first field of view in a first direction. The detector unit may further comprise a second sensor pair, comprising a third microphone and a fourth microphone. The second sensor pair may be mounted on a second face of the detector unit. The second sensor pair may provide a second field of view in a second direction. The detector unit may further comprise a third sensor pair, comprising a fifth microphone and a sixth microphone. The third sensor pair may be mounted on the third face of the detector unit. The third sensor pair may provide a third field of view in a third direction. Each of the first, second, and third directions may be offset from the other two directions by 120°. The first, second, and third sensor pairs may together provide the detector unit with a 360° field of view. The detector unit may further comprise a fourth sensor pair, comprising a seventh microphone and an eighth microphone. The fourth sensor pair may be mounted on the fourth face of the detector unit. The fourth sensor pair may provide a fourth field of view in a fourth direction. The first, second, third, and fourth sensor pairs may be arranged in a square, with their respective facing directions pointing outwards from the square.

Providing the detector unit with multiple sensing regions provides the detector unit with an expanded field of view, enabling the detection and tracking of unmanned aerial vehicles over a greater area. Providing detector units with increased fields of view also facilitates the provision of a UAV detection and tracking system covering a wide area, as it simplifies the arrangement of the detector units such that their fields of view overlap.

It may be that the detector unit has a range of less than 500 m, preferably less than 450 m, more preferably less than 350 m.

It may be that the detector unit is configured to sample audio data from each of the first microphone and the second microphone. In such cases, the audio data may be sampled at a rate of greater than 5 kHz, preferably greater than 10 kHz, more preferably greater than 20 kHz, yet more preferably greater than 40 kHz.

The monitoring may be performed using one or both of the first microphone and the second microphone. Alternatively or additionally, a further microphone may be used for the monitoring.

It may be that the computing node is located apart from the detector unit. It may be that the computing node is separated from the detector unit by more than 10 m, preferably more than 25 m, more preferably more than 50 m, yet more preferably more than 100 m. It may be that the computing node is a separate unit to the detector unit. Thus, it may be that the computing node is remote from the detector unit. Alternatively, the computing node may be co-located with the detector unit.

The method may further comprise receiving, at the computing node, from the detector unit, the transmitted azimuth angle. The method may further comprise receiving, at the computing node, from a second detector unit, a second azimuth angle to the unmanned aerial vehicle from the second detector unit. In such cases, the method may comprise, at the computing node, on the basis of the azimuth angle, the second azimuth angle, and known positions of the detector unit and the second detector unit, determining a ground location of the unmanned aerial vehicle.

It will be appreciated that a “ground location” refers to a location of the unmanned aerial vehicle not including information on its height. Thus, the method provides means to determine the location of an unmanned aerial vehicle and, by repeating the method over a period of time, to track its movement. The ability to determine and track the ground location of a detected unmanned aerial vehicle enables greatly improved situational awareness, allowing a user of a UAV detection system according to embodiments of the invention to more effectively identify whether a detected unmanned aerial vehicle poses a threat and, if so, to what extent.

It may be that the computing node is located apart from the detector unit and the second detector unit. It may be that the computing node is separated from the detector unit and the second detector unit by more than 10 m, preferably more than 25 m, more preferably more than 50 m, yet more preferably more than 100 m. It may be that the computing node is a separate unit to the detector unit and the second detector unit. Thus, it may be that the computing node is remote from the detector unit and the second detector unit.

It may be that the detector unit comprises a third microphone. The third microphone may positioned at a different height to the first microphone and/or the second microphone. In such cases, the method may comprise, in response to the monitoring indicating the presence of the unmanned aerial vehicle, determining an additional phase delay between the sound as received at the third microphone and the sound as received at one of the first microphone and the second microphone. The method may further comprise, on the basis of the determined additional phase delay and a known separation of the third microphone and the one of the first microphone and the second microphone, determining an elevation angle to the unmanned aerial vehicle from the detector unit. The method may further comprise transmitting, to a computing node, the determined elevation angle for use in determining a location of the unmanned aerial vehicle.

Such embodiments can enable a height of the unmanned aerial vehicle to be determined, rather than merely a ground location. The ability to determine a height of a detected unmanned aerial vehicle enables further improved situational awareness.

Alternatively, it may be that the method does not comprise determining and/or transmitting an elevation angle. Such embodiments can reduce the quantity of information that must be transmitted to the computing node. This reduction in the quantity of information to be transmitted can provide reduce pressure on (by reducing utilisation of) a datalink between the detector unit and the computing node, enabling the datalink to operate over greater distances and in degraded communications environments. Such a feature is of particular use in embodiments of the invention in which the UAV detection system includes a large number of detector units, where such features help to prevent the datalinks between the detector units and the computing node becoming saturated and excessively congested, resulting in a loss of performance. Furthermore, such embodiments can reduce the processing load on the detector unit, further facilitating the use of a decentralised computing system.

Where the method comprises transmitting an elevation angle, the method may further comprise, at the computing node, receiving, from the detector unit, the transmitted elevation angle. In such cases, the method may further comprise determining a height of the unmanned aerial vehicle. It may be that the height is determined on the basis of the determined ground position and the received elevation angle.

Thus, such embodiments enable a location in 3D space of the unmanned aerial vehicle, rather than merely a ground position.

It may be that determining the location of the unmanned aerial vehicle comprises triangulating its location.

The method may further comprise, whilst the unmanned aerial vehicle is in the vicinity of the detector unit, monitoring for a further sound associated with the presence of a further unmanned aerial vehicle in the vicinity of the detector unit. In such cases, the method may further comprise, in response to the monitoring indicating the presence of the further unmanned aerial vehicle, determining a further phase delay between the sound as received at the first microphone and the sound as received at the second microphone. The method may further comprise, on the basis of the determined further phase delay and the known separation of the first microphone and the second microphone, determining a further azimuth angle to the further unmanned aerial vehicle from the detector unit. The method may further comprise, transmitting, to the computing node, the determined further azimuth angle for use in determining a location of the further unmanned aerial vehicle.

Where the method comprises determining and transmitting a further azimuth angle to a further unmanned aerial vehicle, the method may further comprise receiving, from the detector unit, the transmitted further azimuth angle. The method may also comprise receiving, from a further detector unit, a further azimuth angle to the unmanned aerial vehicle from the second detector unit. In such cases, the method may further comprise, on the basis of the further azimuth angle, the second further azimuth angle, and known positions of the detector unit and the further detector unit, determining a ground location of the further unmanned aerial vehicle.

Thus, embodiments of the invention can enable the detection and tracking of multiple unmanned aerial vehicles simultaneously. Furthermore, such functionality can enable the UAV detection and tracking system to function effectively even in the event of a “swarm attack”, in which a large number of unmanned aerial vehicles are deployed simultaneously.

Determining a ground location of the further unmanned aerial vehicle may further comprise determining a plurality of possible ground locations of the further unmanned aerial vehicle. Determining aground location of the further unmanned aerial vehicle may further comprise predicting, on the basis of previous motion of the further unmanned aerial vehicle, a future location of the further unmanned aerial vehicle. In such cases, determining a ground location of the further unmanned aerial vehicle may further comprise identifying one of the determined plurality of possible ground locations that most closely matches the predicted future location.

Determining a ground location of the further unmanned aerial vehicle on the basis of a prediction of a future location of the further unmanned aerial vehicle enables the computing node to distinguishing between multiple unmanned aerial vehicles detected by the same detector units, and therefore enables tracking of multiple unmanned aerial vehicles.

The azimuth angle may be transmitted to the computing node using a wireless datalink. Use of a wireless datalink to enable transmission of the azimuth angle, can enable the detector units to be deployed more quickly and easily by removing the need to run cables between the detector units and the computing node. This is of particular benefit in large-scale deployments of the UAV detector system, where otherwise large numbers and lengths of cables would be required to connect all of the deployed detector units to the computing node. Use of a wireless datalink can also facilitate the deployment of detector units at greater distances from the computing node, over which it would be impractical to lay a cable. Alternatively, the azimuth angle may be transmitted to the computing node using a wired datalink.

It may be that the detector unit and the computing node are connected by a mesh network. In such cases, the determined azimuth angle may be transmitted over the mesh network. Utilising a mesh network to connect the detector units and computing node can increase the range from the computing node at which a deployed detector unit can be located, by allowing one or more further detector units to act as a repeater node within the mesh network. Thus, the determined azimuth angle may be transmitted to the computing node via a further detector unit. Furthermore, such features can enable a given detector unit to communicate with the computing node even in cases where no direct signal transmission path is available between the given detector unit and the computing node (for example, due to an obstruction).

It may be that determining the phase delay comprises performing a cross-correlation (for example, of the sound as received at the first microphone and the sound as received at the second microphone). Cross-correlation provides a computationally simple method for determining the phase delay between the sound as received at the first microphone and as received at the second microphone. Cross-correlation can be used to determine the phase delay (and thereby the azimuth angle) is on the basis of the sound as received at a pair of microphones. Where more than two microphones are to be used, it is necessary to treat the microphones as multiple pairs, perform a cross-correlation for each pair, and then combine the resulting outputs. Alternatively, beam-forming techniques can be employed to determine the azimuth angle based on sound as received at multiple microphones, however this is much more computationally complex and therefore requires greater computing power. The reduction in computational complexity provided by use of cross-correlation of two audio signals allows a reduction in the computing power required to detect and determine an azimuth angle of an unmanned aerial vehicle. This facilitates the performance of the required processing at the detector unit, as opposed to in a large centralised computing resource. Thus, the simplification of the processing facilitates the provision of a decentralised computing system, and thereby also the scalability of the UAV detection system of the invention. The reduced computational complexity can also reduce the power consumption of the detector unit, extending the period of time over which the detector unit can operate using battery power.

It may be that determining the phase delay comprises performing a Fourier transform (for example, on the sound as received at each of the first microphone and the second microphone). It may be that the cross-correlation is performed on the outputs of the Fourier transforms.

It may be that determining the azimuth angle from the detector unit to the unmanned aerial vehicle comprises operating a machine learning agent. The machine learning agent may comprise a convolutional neural network. It may be that the machine learning agent is configured to determine the azimuth angle on the basis of the cross-correlation. Use of a machine learning agent to determine the azimuth angle can enable the processing required for detection and tracking of unmanned aerial vehicles to be performed more quickly. This further facilitates the performance of the required processing for UAV detection and tracking at the detector unit (as opposed to in a large centralised computing resource) and thereby also the use of a decentralised computing system, providing a readily scalable UAV detection and tracking system.

It may be that the method further comprises processing audio data from one or both of the first microphone and the second microphone to classify according to their likely source one or more sounds represented in the audio data. The method may further comprise ignoring sounds classified as corresponding to noises sources other than unmanned aerial vehicles.

The method may further comprise notionally sub-dividing the field-of-view of the detector unit into a plurality of discrete angular sectors. It may be that the angular width of each sector in the plurality corresponds to the angular sensitivity of the detector unit. It may be that determining the azimuth angle comprises determining, for each of the notional sectors, a probability that an unmanned aerial vehicle is present within the respective notional sector. The method may further comprise comparing each of the determined probability against a pre-determined threshold. In such cases, it may be that a probability exceeding the pre-determined threshold is indicative of the presence of an unmanned aerial vehicle.

The method may further comprise, at the computing node, in response to receipt of the azimuth angle, generating an alert indicating that an unmanned aerial vehicle has been detected. The alert may comprise one or more of, generating an audible noise, lighting a light, displaying a visual warning on a display associated with the computing node. Such a visual warning may include an indication of the determined location of the unmanned aerial vehicle. Where an azimuth angle has been received only from a single detector unit (and thus it is not possible to determine a point location of the unmanned aerial vehicle) the visual warning may comprise an indication of a bearing from the detector unit along which the unmanned aerial vehicle has been determined to be located. Alternatively or additionally, the alert may comprise transmission of a signal to one or more further computing systems (for example, a command and control system or a UAV countermeasure control system).

Alternatively or additionally, the method may further comprise, in response to receipt of the azimuth angle, causing action to be taken to impede the operation of the unmanned aerial vehicle. Such action may comprise one or more of: jamming wireless communications to and/or from the unmanned aerial vehicle, physically capturing the unmanned aerial vehicle, damaging or destroying the unmanned aerial vehicle, or otherwise disabling the unmanned aerial vehicle. It will be appreciated by the skilled person that any known UAV countermeasures may be used to prevent or to inhibit the operation of the unmanned aerial vehicle.

It may be that the detector unit comprises a battery, and is arranged to operate using battery power. Providing the detector unit with a battery can facilitate deployment of the detector unit rapidly and in locations not having reliable power distribution. Thus, the detector unit may be capable of operating on either of battery power and mains electricity from a power grid.

The second aspect of the invention provides a computer program comprising a set of instructions, which, when executed by a computer, cause the computer to perform a method according to the first aspect.

The third aspect of the invention provides a detector unit for detecting and tracking an unmanned aerial vehicle. The detector unit comprises:

a first microphone;

a second microphone;

a signal processing module configured to:
monitor for a sound associated with the presence of the unmanned aerial vehicle in the vicinity of the detector unit,
in response to the monitoring indicating the presence of the unmanned aerial vehicle, determine a phase delay between the sound as received at the first microphone and the sound as received at the second microphone, and
on the basis of the determined phase delay and a known separation of the first microphone and the second microphone, determine an azimuth angle to the unmanned aerial vehicle from the detector unit, and

a transmitter module configured to transmit, to a computing node, the determined azimuth angle for use in determining a location of the unmanned aerial vehicle.

The fourth aspect of the invention provides a system for detecting and tracking an unmanned aerial vehicle. The system comprises:

a plurality of detection units according to the third aspect; and

a computing node configured to:
receive, from a first detection unit in the plurality, a first azimuth angle from the first detection unit to the unmanned aerial vehicle;
receive, from a second detection unit in the plurality, a second azimuth angle from the second detection unit to the unmanned aerial vehicle; and
determine, on the basis of the first azimuth angle, the second azimuth angle, and known locations of the first detection unit and the second detection unit, a ground location of the unmanned aerial vehicle.

The system may comprise at least 10 detection units, preferably at least 25 detection units, more preferably at least 50 detection units, yet more preferably at least 75 detection units.

The detection units may be connected to the computing node by a wireless communication network. The plurality of detection units may be connected to the computing node by a mesh network. It may be that at least one detection unit in the plurality communicates with the computing node only via a second detection unit in the plurality. It may be that each of the plurality of detector units is configured to act as a repeater for signals to the computing node transmitted by other detector units in the plurality.

It may be that each of the detector units in the plurality is positioned such that its field of view at least partially overlaps the field of view of another detector unit in the plurality. It may be that the plurality of detector units are arranged in a line, such that the field of view of each detector unit at least partially overlaps the fields of view of the two adjacent detector units in the plurality. It may be that the plurality of detector units are arranged in a grid formation.

It may be that at least one of the detector units in the plurality is located apart from another detector units in the plurality. It may be that at least one of the detector units in the plurality is located apart from all of the other detector units in the plurality. It may be that each of the detector units in the plurality is located apart from all of the other detector units in the plurality. It may be that each of the detector units in the plurality is separated from the other detector units in the plurality by at least 20 m, preferably at least 50 m, more preferably at least 80 m, yet more preferably at least 120 m. It may be that each of the detector units in the plurality is located between 50 m and 300 m apart from another detector unit in the plurality (for example, the nearest other detector unit in the plurality), preferably between 100 m and 250 m, more preferably between 150 m and 200 m.

It may be that the computing node is located apart from one or more (for example, all) of the detector units in the plurality. It may be that the computing node is co-located with at least one of the detector units in the plurality. It may be that the computing node is a separate unit to one or more (for example, all) of the detector units in the plurality. Thus, it may be that the computing node is remote from one or more (for example, all) of the detector units. It may be that the system includes only a single computing node.

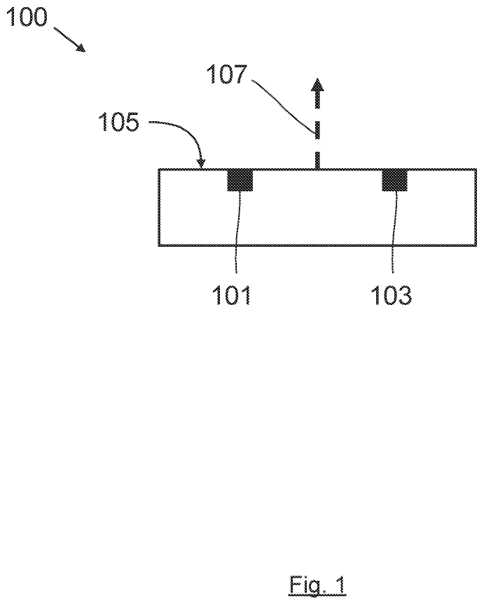

FIG. 1 shows a schematic view of a detector unit 100 according to a first embodiment of the invention. The detector unit 100 comprises a first microphone 101 and a second microphone 103, each of which is mounted in a front facing surface 105 of the detector unit 100. The first microphone 101 and the second microphone 103 can together be considered to constitute a sensor pair. The first microphone 101 and the second microphone 103 are uni-directional and are mounted in the front facing surface 105 so as to be sensitive to sound received from the front of the detector unit and to reject sound from the rear of the detector unit 100. The detector unit 100 therefore can be said to comprise a sensing region, extending outwards from the front surface 105 of the detector unit in a direction represented by arrow 107, within which the detector unit 100, by use of the first microphone 101 and the second microphone 103, is capable of detecting noise sources.

The first microphone 101 and the second microphone 103 are spaced apart from one another, but are arranged such that, when the detector unit 100 is in use, the first microphone 101 and the second microphone 103 are positioned at substantially the same height. The spacing distance between the first microphone 101 and the second microphone 103 can be referred to as an “aperture”. This example embodiment has an aperture size of 50 cm (meaning that the first microphone 101 and the second microphone 103 are spaced 50 cm apart). However, the skilled person will appreciate that, in other embodiments, other aperture sizes can also be used.

Because the first microphone 101 and the second microphone 103 are spaced apart from one another, a sound emitted by a noise source within the sensing region will be received at the first microphone 101 and the second microphone 103 at different times. Thus, for a given sound, one of the two microphones will receive a delayed version of the sound compared to that received by the other. The magnitude of the delay and the order in which the two microphones receive the sound is determined by the position of the noise source within the sensing region. This delay manifests itself as a phase delay between the sounds as received at the first microphone 101 and the second microphone 103. Because the first microphone 101 and the second microphone 103 are arranged such that they are positioned at the same height when in use, that phase delay is indicative of an azimuth angle of the noise source from the sensor pair.

As previously mentioned, the first microphone 101 and the second microphone 103 are directional, such that they primarily detect sounds emitted from noise sources in front of the sensor pair (the front of the sensing region corresponding to direction 107). The sensor pair can therefore be considered to have a “field of view”, defining an angular sector extending outwards from the sensor pair (in and centred on direction 107) in which a noise source is detectable by the sensor pair. In this particular example, the sensor pair has a field of view of approximately 120°, arranged symmetrically about an axis normal to the front facing surface 105 (i.e. centred on direction 107). Thus, looking at FIG. 1, direction 107 can be considered to correspond to an angle of 0°, with positive angles to the right of direction 107 and negative angles to the left. It will be appreciated that, although the angles have been described by reference to direction 107 in this example, other embodiments may define such angles by reference to any other reference direction. Thus, in this case, an angle of 0° can be considered to be boresight, and the sensor pair's field of view of 120° allows the sensor pair to detect noise sources at up to 60° off-boresight. It will be appreciated that the field of view described above is purely an example, and that other embodiments of the invention may have a different field of view and may also define angles relative to a different reference direction.

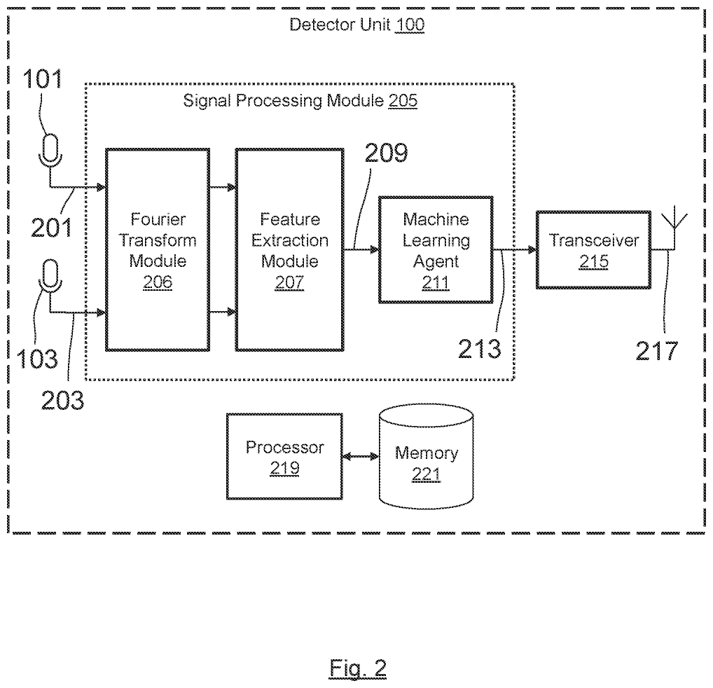

FIG. 2 shows a functional block diagram of the detector unit 100. The first microphone 101 is configured to generate first audio data 201 corresponding to the sound detected by the first microphone 101. The second microphone 101 is configured to generate second audio data 203 corresponding to the sound detected by the second microphone 101.

In this example embodiment, the audio data 201, 203 from the first microphone 101 and the second microphone 103 are each sampled at a rate of 48 kHz. However, other sampling rates may also be used (for example, 96 kHz). It will be appreciated that the magnitude of the phase delay associated with a given change in the azimuth angle to a noise source is determined by the aperture size. It will also be appreciated that the size of the smallest phase delay that can be detected is determined by the sampling rate of the first microphone 101 and the second microphone 103. Thus, the aperture size and the sampling rate of the microphones together determine the resolution with which the detector unit 100 can identify an azimuth angle to a noise source. An increased aperture size and/or an increased sampling rate yields increased precision.

The sampled audio data is transmitted to a signal processing module 205. The signal processing module 205 comprises a Fourier transform module 206. The Fourier transform module 206 is configured to calculate Fourier transforms (in this example, by use of Fast Fourier Transforms) of the two sampled audio streams to produce two frequency domain representations of the audio data (one representation for each of the two sets of audio data). In this example embodiment, the Fourier transforms are calculated on the basis of 40% samples of audio data. However, it will be appreciated that, in other embodiments, the Fourier transforms may be calculated on the basis of other numbers of samples.

The signal processing module 205 further comprises a feature extraction module 207. The feature extraction module 207 is configured to operate a cross-correlation algorithm, which is applied to the two frequency domain representations, to produce a single cross-correlated two-dimensional array 209. In this example embodiment, the feature extraction module 207 is configured to, on the basis of the frequency domain representations, perform a Generalised Cross-Correlation with Phase Transform mapped to Filter Banks (GCCPT-FB). The resulting array can be treated as an image having a first axis associated with phase delay and a second axis associated with frequency. Thus, a detected noise source manifests itself within the image as a “hot-spot” at a point corresponding to a frequency of the detected sound and a phase delay between the sound as received at the two microphones. Thus, the feature extraction module 207 can be said to be configured to determine a phase delay between the sound as received at the first microphone and the sound as received at the second microphone.

The resulting cross-correlated array 209 therefore contains information characterising the phase delay between sounds arriving at the microphones 101, 103, allowing it to be used to determine a direction from which the sound was received.

It will be understood by the skilled person that calculating a GCCPT-FB comprises applying a filter bank comprising a plurality of triangular filters arranged on the mel scale. A GCCPT-FB can be calculated by use of the following equation:

$${g}_{ij} ( f , τ ) = \frac{{\sum }_{ω ∈ {Ω}_{f}} ℛ ( {H}_{f} ( ω ) \frac{{X}_{i} ( ω ) {{X}_{j} ( ω )}^{*}}{\vert {X}_{i} ( ω ) {{X}_{j} ( ω )}^{*} \vert} {e}^{j ωτ} )}{{\sum }_{ω ∈ {Ω}_{f}} {H}_{f} ( ω )}$$

### Where:

gᵢⱼ(f, τ)=Cross-Correlation between channel ‘i’ and ‘j’ for a given value of filter bank index and inter-channel time delay
f=Filter Bank index
τ=Inter-channel time delay in discrete samples
H_{f}(ω)=Transfer function for the f-th mel-scaled triangular filter
Ω_{f}=Support for H_{f}(ω)
Xᵢ (ω)=Short Time Fourier Transform for channel ‘i’
Xⱼ(ω)*=Complex conjugate of the Short Time Fourier Transform for channel ‘j’

Whilst, in this particular embodiment, triangular filters are used, it will be appreciated that, in other embodiments, the filter bank may comprise other filters (for example, elliptic filters).

The signal processing module 205 further comprises a machine learning agent 211. The machine learning agent 211, in this particular example embodiment, comprises a convolutional neural network. It will, however, be appreciated that other types of neural network, and also other types of machine learning agent, may also be used.

The machine learning agent 211 is configured to process the cross-correlated array 209 to identify and classify according to their likely source one or more sounds represented in the cross-correlated array 209. By classifying sounds according to their likely source, it is possible to filter detected sounds to exclude those arising from noise sources which are not of interest. The classification is performed on the basis of the frequency content of the received sound (as characterised by cross-correlated array 209). In this case, the detector unit 100 is intended for use in detecting and tracking unmanned aerial vehicles, and the machine learning agent is therefore configured to ignore sounds which are classified as corresponding to noises sources other than unmanned aerial vehicles (for example, sound emitted by airplanes flying overhead or road vehicles driving on a nearby road).

The detector unit 100 is configured to notionally sub-divide the field-of-view of the sensor pair into a plurality of discrete angular sectors, the angular width of each sector in the plurality corresponding roughly to the angular sensitivity of the detector unit (which, as mentioned previously, is determined by the microphone sampling frequency and the aperture size). The machine learning agent 211 is further configured to determine, for each of the notional sectors, a probability that an unmanned aerial vehicle is present within the respective notional sector. In this example embodiment, the detector unit 100 has an angular resolution of approximately 1° and has only a single sensor pair with a field of view of approximately 120°. Thus, the machine learning agent is configured to determine 120 probabilities (one corresponding to each of the notional sectors) that an unmanned aerial vehicle is present in the respective notional sector. The probabilities are determined on the basis of the phase delay between the sounds as received at the first microphone 101 and the sound as received at the second microphone 103 (as characterised by cross-correlated array 209) and on the basis of a known separation of the first microphone 101 and the second microphone 103. The probabilities are further determined on the basis of the frequency content of the received sound (as also characterised by cross-correlated array 209), in order to determine a likelihood that the received sound corresponds to an unmanned aerial vehicle. Thus, sounds emanating from noise sources other than unmanned aerial vehicles are rejected. Where an unmanned aerial vehicle is present within the field of view of the detector unit 100, the determined probabilities will comprise an indication of an azimuth angle to the detected unmanned aerial vehicle.

The determined probabilities are output from the machine learning agent 211 as a one-dimensional array, in which each element of the array corresponds to a given one of the notional angular sectors. Each element in the array contains a value between 0 and 1 indicating the determined probability of that associated angular sector containing an unmanned aerial vehicle.

Thus, the machine learning agent 211 can be said to be configured to determine an azimuth angle from the detector unit 100 to an unmanned aerial vehicle in the vicinity of the detector unit 100. The machine learning agent 211 can also be said to be configured to determine the azimuth angle on the basis of the cross-correlation. It will be appreciated that, in this context, the extent of “the vicinity of the detector unit” is determined by the effective range of the detector unit. This range can be affected by the specific environment in which the detector unit is deployed (for example, due to factors such as the magnitude of any background noise present, the quantity of obstacles surrounding the detector unit, and the contours of the surrounding terrain) and also by the type and size of the unmanned aerial vehicle. In the case of a 1.5 kg-3 kg drone this range is typically in the region of 200 m-300 m.

It will be appreciated that, in this example embodiment (i.e. in which the signal processing module 205 operates using a machine learning agent), the determination of the azimuth angle (as defined by the determined probabilities) on the basis of phase delay and the known separation is not hard-coded into the machine learning agent 211. Rather, the machine learning agent 211 is configured to operate on this basis by a process of training the machine learning agent to operate using the available data (i.e. data characterising the phase delay and the frequency content of the received sounds) and within the physical constraints imposed on the machine learning agent 211 (i.e. including the predetermined fixed separation of the first microphone 101 and the second microphone 103). Thus, the machine learning agent 211 can be said to be configured (by virtue of its training) to determine an azimuth angle to the unmanned aerial vehicle from the detector unit.

It will be appreciated that the detector unit 100 alone is not capable of determining specific position of an unmanned aerial vehicle. The detector unit 100 is only capable of determining a bearing from the detector unit 100 to the unmanned vehicle and cannot determine the distance of the unmanned aerial vehicle from the detector unit 100 along that bearing. Furthermore, in this example embodiment, the detector unit is capable only of determine an azimuth angle to an unmanned aerial vehicle, not an angle of elevation. However, in other embodiments described in more detail below, the detector unit 100 may be configured to determine both azimuth and elevation angles to the unmanned aerial vehicle.

When in operation, the signal processing module 205 is configured to continually sample and process the audio data 201, 203 to generate cross-correlated arrays 209 for input into the machine learning agent 211. Similarly, the machine learning agent is configured to continually evaluate the cross-correlated arrays 209 to detect and locate any unmanned aerial vehicles in the vicinity of the detector unit 100. Thus, the detector unit 100 can be said to be configured to monitor for a sound associated with the presence of an unmanned aerial vehicle in the vicinity of the detector unit 100. Thus, the detector unit 100 is suitable for use in detecting and tracking unmanned aerial vehicles.

The signal processing module 205 is further configured to compare each of the determined probabilities with a pre-determined threshold. A probability exceeding the pre-determined threshold is considered to be indicative of the presence of an unmanned aerial vehicle in the corresponding notional sector. Thus, the determined probabilities constitute an indication of a determined azimuth angle to the unmanned aerial vehicle. Thus, the detector unit 100 can be said to have determined an azimuth angle from the detector unit 100 to the unmanned aerial vehicle.

The detector unit 100 further comprises a transceiver 215. In response to one or more of the determined probabilities exceeding the predetermined threshold, the transmitter 215 is configured to transmit the determined azimuth angle to a computing node (for example, for use in determining a location of the unmanned aerial vehicle). The detector unit 100 is configured to transmit the determined azimuth angle by use of a wireless datalink. To that end, the detector unit 100 further comprises an antenna 217, by use of which the transmitter 215 is configured to transmit the determined azimuth angle. It will be appreciated that the transmission of the azimuth angle will take the form of transmission of a signal indicative of the azimuth angle. The specific format and structure of this signal is unimportant and the skilled person will be aware of a number of protocols and formats suitable for performing such a transmission. The transceiver 215 may be configured to transmit an identifier of the one or more notional sectors associated with the one or more probabilities which exceed the predetermined threshold. Such an identifier may take the form of a unique reference ID of the notional sector. Alternatively, the identifier may take the form of the azimuth angle (or range of azimuth angles) associated with those notional sectors. It will be appreciated that both of these options are functionally equivalent, and therefore both will henceforth be referred to as simply a determined azimuth angle.

In alternative embodiments, the transceiver is configured to transmit the full set of determined probabilities, rather than only the determined azimuth angle. It will be appreciated that transmitting the determined probabilities, where one or more of the determined probabilities exceeds the predetermined threshold and therefore indicates the presence of an unmanned aerial vehicle, is functionally equivalent to transmitting only the azimuth angles corresponding to those notional sectors having probabilities exceeding the predetermined threshold.

The transceiver 215 and the antenna 217 are configured to enable the detector unit 100 to connect to and communicate over a wireless network. In this case, the wireless network comprises a mesh network and the determined azimuth angle is transmitted over the mesh network. Thus, in some cases (for example, where a direct transmission path to the computing node is not available), the determined azimuth angle is transmitted to the computing node via one or more further devices connected to the mesh network. Such further devices may include one or more further detector units.

The detector unit 100 is also capable of detecting and locating more than one unmanned aerial vehicle simultaneously. It will be appreciated that, where more than one unmanned aerial vehicle is present within the vicinity of the detector unit 100, the operation of the system as described above is predominantly unchanged, with the exception that the determined probabilities will indicate more than one notional sector as containing an unmanned aerial vehicle, and therefore the detector unit 100 will transmit more than one azimuth angle to the computing node. Thus, the detector unit 100 can also be said to be configured to monitoring for a further sound associated with the presence of a further unmanned aerial vehicle in the vicinity of the detector unit: determine a further phase delay between the further sound as received at the first microphone and the sound as received at the second microphone; on the basis of the determined further phase delay and the known separation of the first microphone and the second microphone, determine a further azimuth angle to the further unmanned aerial vehicle from the detector unit; and transmit, to the computing node, the determined further azimuth angle for use in determining a location of the further unmanned aerial vehicle.

In alternative embodiments in which the full set of determined probabilities are transmitted to the computing node, there is no need for any additional transmission to convey the further azimuth angle to the computing node; both the azimuth angle (i.e. of the first unmanned aerial vehicle) and the further azimuth angle (i.e. of the further unmanned aerial vehicle) are conveyed to the computing node by transmission of the full set of determined probabilities.

The detector unit 100 comprises a processor 219 and an associated memory 221. It may be that some or all of the functionality of the signal processing module 205, the Fourier transform module 206, the feature extraction module 207, the machine learning agent 211, and the transceiver 215 is implemented partially or wholly by the processor 219 (for example, by executing instructions stored in the memory 221).

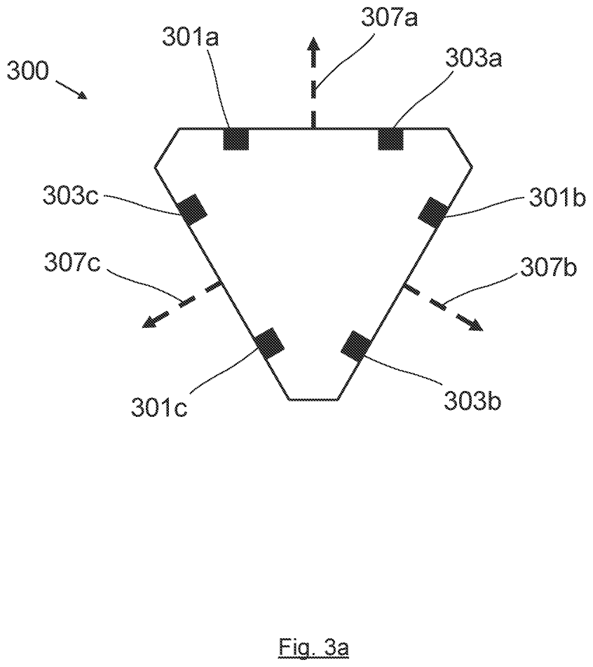

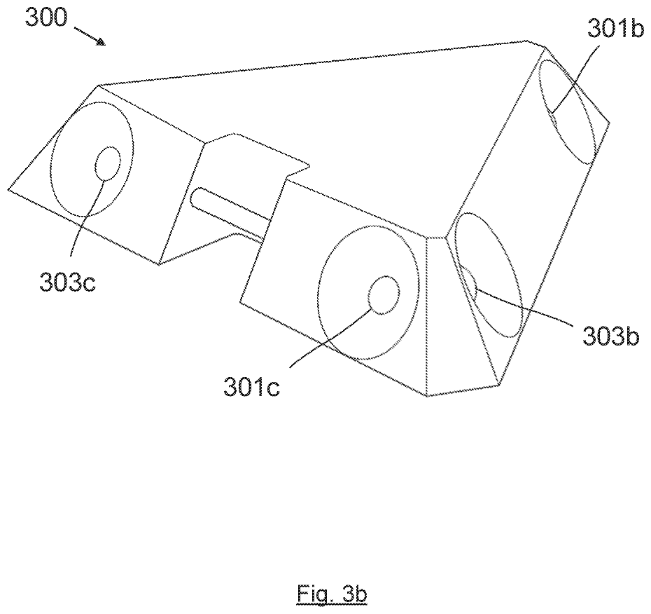

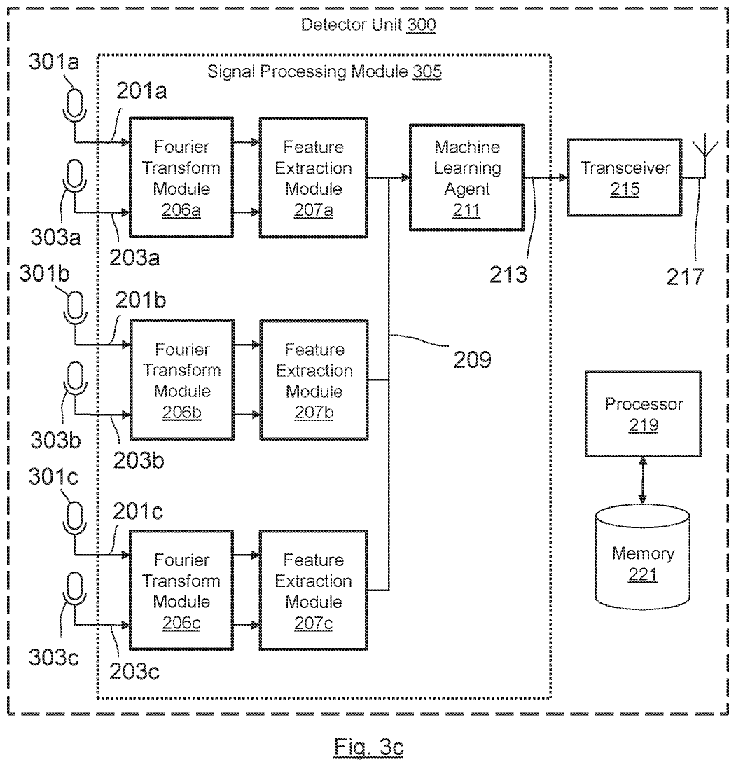

FIG. 3a shows a schematic view (in plan view) of a detector unit 300 according to a second embodiment of the invention. FIG. 3b shows a perspective view of the detector unit 300. In this example embodiment, the detector unit 300 is of a triangular shape and comprises a sensor pair on each of its three vertical faces. The detector unit 300 comprises a first sensor pair having a first microphone 301a and a second microphone 303a both mounted on a first face of the detector unit 300, which together provide a first field of view in a first direction 307a. The detector unit 300 further comprises a second sensor pair having a first microphone 301b and a second microphone 303b both mounted on a second face of the detector unit 300, which together provide a second field of view in a second direction 307b. The detector unit 300 further comprises a third sensor pair having a first microphone 301c and a second microphone 303c both mounted on the third face of the detector unit 300, which together provide a third field of view in a third direction 307c. Each of the three directions 307a, 307b, 307c faced by the sensor pairs is offset 1200 compared to the other two sensor pairs. As in the first detector unit 100 of the first embodiment, each sensor pair has a field of view of approximately 150°. Thus, the three sensor pairs together provide the detector unit 300 with a 360° field of view. Therefore, whereas the detector unit 100 of the first embodiment was capable of detecting and locating unmanned aerial vehicles only when they were located in front of the detector unit 100, the detector unit 30) of the second embodiment is capable of detecting and locating unmanned aerial vehicles in all directions about the detector unit 300.

The detector unit 300 operates in predominantly the same way as described above in respect of the detector unit 100 of the first embodiment, but for the following differences.

The detector unit 300 is configured to process the audio data from each sensor pair independently, in the same way as described above in respect of the detector unit 100 of the first embodiment, up to the point at which a cross-correlated three-dimensional image has been produced in respect of each of the three sensor pairs. FIG. 3c shows a functional block diagram of the detector unit 300. In this example embodiment, as detector unit 300 comprises three microphone pairs, the signal processing module 305 comprises three Fourier transform modules 206a, 206b, 206c (one for each of the three microphone pairs). Similarly, the signal processing module 305 also comprises three feature extraction modules 207a, 207b, 207c (again, one for each of the three microphone pairs). The audio data 201a, 203a from the first microphone pair is processed by the first Fourier transform module 206a and the first feature extraction module 207a. The audio data 201b, 203b from the second microphone pair is processed by the second Fourier transform module 206b and the second feature extraction module 207b. The audio data 201c, 203c from the third microphone pair is processed by the third Fourier transform module 206c and the third feature extraction module 207c. The outputs of the three feature extraction modules 207a, 207b, 207c (i.e. the three cross-correlated three-dimensional images) are concatenated to produce a single three-dimensional array. The resulting three-dimensional array is then provided to the machine learning agent 211 to enable it to determine an azimuth angle to any unmanned aerial vehicles in the vicinity of the detector unit.

As in the detector unit 100 of the first embodiment, the output of the machine learning agent comprises a single one-dimensional array in which each element of the array corresponds to a given one of the notional angular sectors within the detector unit's field of view. However, as in this example embodiment the detector unit has a 3600 field of view, the one-dimensional array in this case comprises 360 elements.

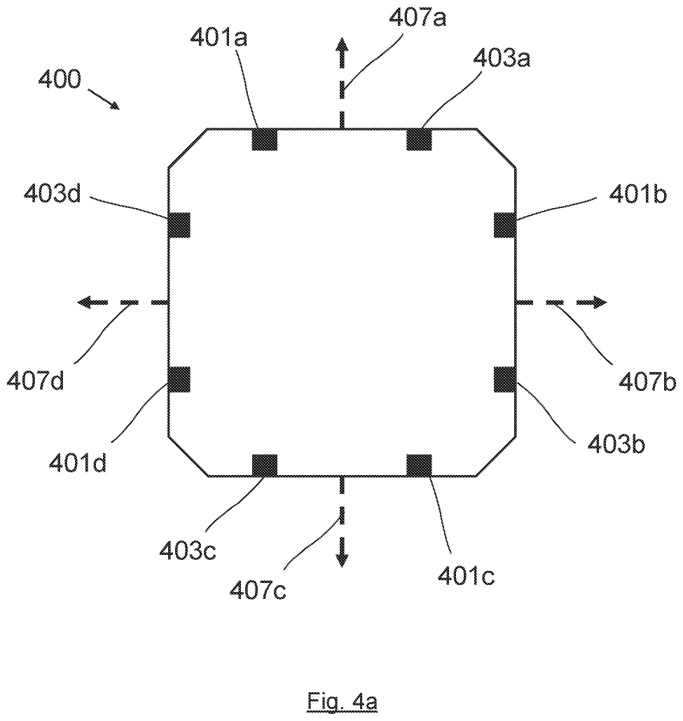

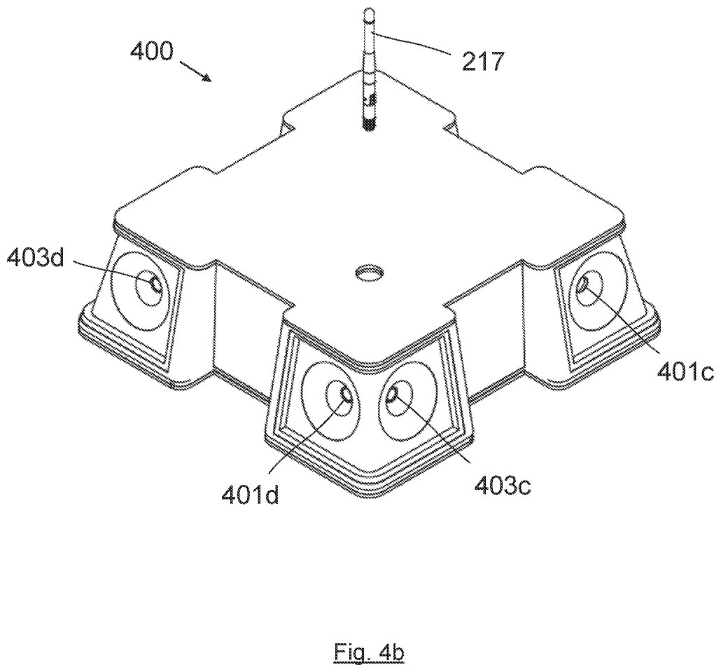

FIG. 4a shows a schematic view (in plan view) of a detector unit 400 according to a third embodiment of the invention. FIG. 4b shows a perspective view of the detector unit 400. In this example embodiment, the detector unit 400 is of a square shape and comprises a sensor pair on each of its four vertical faces. The detector unit 400 comprises a first sensor pair having a first microphone 401a and a second microphone 403a both mounted on a first face of the detector unit 400, which together provide a first field of view in a first direction 407a. The detector unit 400 further comprises a second sensor pair having a first microphone 401b and a second microphone 403b both mounted on a second face of the detector unit 400, which together provide a second field of view in a second direction 407b. The detector unit 400 further comprises a third sensor pair having a first microphone 401c and a second microphone 403c both mounted on a third face of the detector unit 400, which together provide a third field of view in a third direction 407c. The detector unit 400 further comprises a fourth sensor pair having a first microphone 401d and a second microphone 403d both mounted on the fourth face of the detector unit 400, which together provide a fourth field of view in a fourth direction 407d. Each of the four directions 407a, 407b, 407c, 407d faced by the sensor pairs is offset by 90° from those faced by the adjacent two sensor pairs, such that each of the sensor pairs faces in a different direction. Each sensor pair has a field of view of approximately 110° and therefore the four sensor pairs together provide the detector unit 400 with a 360° field of view. Thus, the detector unit 400 is also capable of detecting and locating unmanned aerial vehicles in all directions about the detector unit 400.

The detector unit 400 operates in predominantly the same way as described above in respect of the detector unit 300 of the second embodiment, but for the fact that the four sensor pairs result in four cross-correlated three-dimensional array which are concatenated to form a single three-dimensional array for input into the machine learning agent.

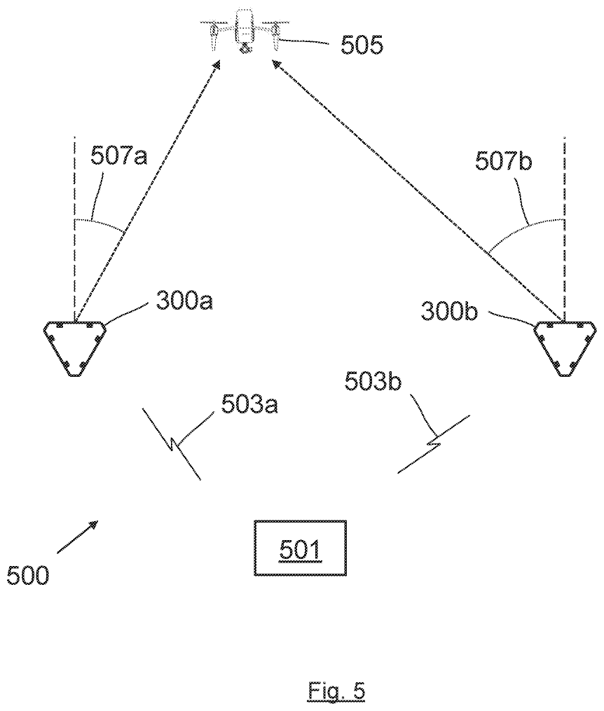

FIG. 5 shows a schematic view of a system 500 according to a fourth embodiment of the invention. The system 500 comprises a plurality of detector units 300a, 300b as described in respect of the second embodiment. For simplicity. FIG. 5 shows only a first detector units 300a and a second detector 300b, but it ill be appreciated that the system 500 may comprise further detector units. Furthermore, although FIG. 5 illustrates a system 500 comprising detector units as described in respect of the second embodiment, it will be appreciated that, in other embodiments of the invention, the system 500 may, alternatively or additionally, comprise detector units as described in respect of the first and third embodiments.

Each of the first detector units 300a and the second detector 300b are configured to operate as previously described. Thus, the detector units 300a, 300b are each configured to monitor for a sound indicative of the presence of an unmanned aerial vehicle in their vicinity and, in response to the monitoring indicating the presence of an unmanned aerial vehicle, determine an azimuth angle from the detector unit to the unmanned aerial vehicle. The detector units 300a. 300b are configured to transmit the determined azimuth angles to a computing node 501. In this example, embodiment, the computing node 501 is located apart from the detector units 300a, 300b, as a separate unit.

In this example embodiment, the computing node 501 is located apart from each of the first detector unit 300a and the second detector unit 300b. The first detector unit 300a is connected to the computing node 501 by a first wireless datalink 503a and the second detector unit 300b is connected to the computing node 501 by second wireless datalink 503b. In this example embodiment, each of the detector units 300a. 300b and the computing node 501 are connected by a mesh network. Thus, if, for example, the first detector unit 300a was positioned such that wireless datalink 503a was unable to provide a direct connection between the first detector unit 300a and the computing node 501 (for example, due to excessive distance between the first detector unit 300a and the computing node 501 or due to an obstruction of a signal propagation path between the first detector unit 300a and the computing node 501), the first detector unit 300a is configured to communicate with the computing node via the second detector unit 300b. Thus, each of the detector units 300a, 300b is configured to act as a repeater for messages transmitted by other detector units to the computing node 501.

The computing node 501 is configured to receive the azimuth angles transmitted from the detector units 300a, 300b and, on the basis of those azimuth angles and known positions of the detector units 300a. 300b, determine (by triangulation) a ground location of the unmanned aerial vehicle. It will be appreciated that, as the detector units 300a, 300b determine and transmit only azimuth angles, not elevation angles, the system 500, the computing node 501 is only capable of determining a ground location of the unmanned aerial vehicle, and not its height. It will be appreciated that, in other embodiments of the invention in which at least one of the detector units also determines an angle of elevation to the unmanned aerial vehicle, the computing node 501 may also be capable of determining a position in 3D space of the unmanned aerial vehicle.

FIG. 5 also shows, as an example to illustrate the operation of system 500, an unmanned aerial vehicle 505 in the vicinity of the detector units 300a, 300b. The first detector unit 300a operates to detect sound emitted by the unmanned aerial vehicle 505 and, on the basis of the detected sound (as described above), determine an azimuth angle 507a from the first detector unit 300a to the unmanned aerial vehicle 505. The first detector unit 300a then transmits the determined azimuth angle 507a to the computing node 501, via the wireless datalink 503a. Independently, the second detector unit 300b also operates to detect sound emitted by the unmanned aerial vehicle 505 and, on the basis of the detected sound (as described above), determine a second azimuth angle 507b from the second detector unit 300b to the unmanned aerial vehicle 505. The second detector unit 300b then transmits the determined second azimuth angle 507b to the computing node 501, via the second wireless datalink 503b. The computing node 501 receives the azimuth angles 507a, 507b from the detector units 300a, 300b and, on the basis of those azimuth angles 507a, 507b and known positions of the detector units 300a, 300b, triangulates a location of the unmanned aerial vehicle. It will be appreciated by the skilled person that the first wireless datalink 503a and the second wireless datalink 503b may together (optionally also with one or more further wireless datalinks) form a single wireless network.

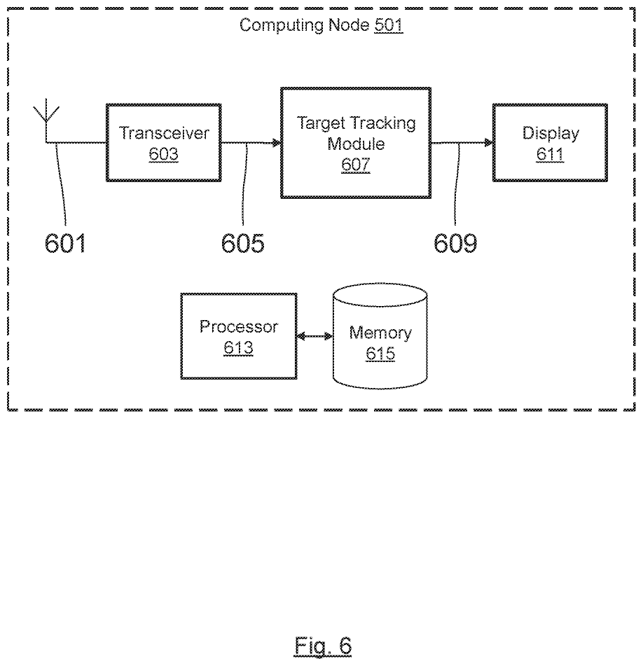

FIG. 6 shows a schematic view of the computing node 501. The computing node comprises an antenna 601 and a transceiver 603. The transceiver is configured to receive from a detector unit, via antenna 601, an azimuth angle from the detector unit to an unmanned aerial vehicle detected in its vicinity. It will be appreciated that the receipt by the computing node 501 of an azimuth angle will take the form of receipt of a signal indicative of the azimuth angle. The transceiver 603 is configured to generate detection data 605 indicating the received azimuth angle and the identity of the detector unit from which the azimuth angle has been received. This detection data 605 is passed to a target tracking module 607.

The target tracking module 607 is configured to, in response to receipt of the detection data 605, generate an alert indicating that an unmanned aerial vehicle has been detected. It will be appreciated that, as only a single azimuth angle has, thus far, been received, the computing node 501 cannot determine a specific point location of the detected unmanned aerial vehicle, and therefore cannot generate an alert including such information. Thus, the alert instead comprises an indication of the detector unit which has detected the unmanned aerial vehicle and a bearing from the detector unit along which the unmanned aerial vehicle is located.

In this example embodiment, generating the alert comprises generating display data 609, which is transmitted to a display 611 associated with computing node 501. It will, however, be appreciated that, in other embodiments of the invention, generating the alert may, alternatively or additionally, comprise one or more of lighting a light, sounding an audible alert, and transmitting a signal to a further computing system (for example, a command and control system, a UAV countermeasure control system, or a further UAV detection and monitoring system). The display 611 is configured to process the display data 609 to generate a user display indicating that an unmanned aerial vehicle has been detected, the specific detector unit which has detected the unmanned aerial vehicle, and the bearing from the detector unit along which the unmanned aerial vehicle has been determined to be located.

The transceiver 603 is further configured to receive, via antenna 601, a further azimuth angle to the unmanned aerial vehicle from the further detector unit. Where the computing node 501 has received a further azimuth angle from the further detector unit, the detection data 605 also indicates the received further azimuth angle and the identity of the further detector unit from which the further azimuth angle. In such cases, the target tracking module 607 is configured to determine, on the basis of the azimuth angle, the further azimuth angle, and known positions of the detector unit and the further detector unit, a ground location of the unmanned aerial vehicle. The target tracking module 607 is configured to determine the ground location of the unmanned aerial vehicle by triangulation. In such cases, the generated alert also includes an indication of the determined ground location of the unmanned aerial vehicle.

The computing node 501 comprises a processor 613 and an associated memory 615. It may be that some of all of the functionality of the transceiver 603 and the target tracking module 607 is implemented partially of wholly by the processor 613 (for example, by executing instructions stored in the memory 615).

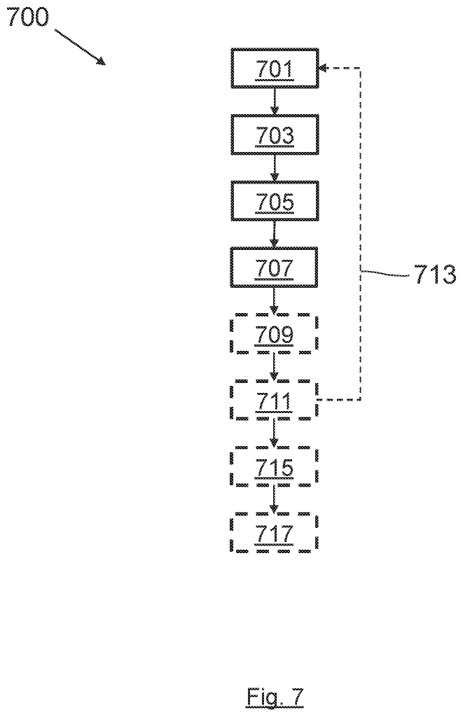

FIG. 7 shows a flow chart illustrating a method 700 of detecting and tracking an unmanned aerial vehicle according to a fifth embodiment of the invention.

A first step, represented by item 701, of the method 700 comprises, at a detector unit comprising a first microphone and a second microphone, monitoring for a sound associated with the presence of the unmanned aerial vehicle in the vicinity of the detector unit.

It may be that the first microphone and second microphone are arranged such that, in use, they are positioned at substantially the same height.

A second step, represented by item 703, of the method 700 comprises, in response to the monitoring indicating the presence of the unmanned aerial vehicle, determining, at the detector unit, a phase delay between the sound as received at the first microphone and the sound as received at the second microphone.

It may be that the detector unit comprises a third microphone, positioned at a different height to the first microphone and the second microphone. In such cases, the method may further comprise an optional step of, in response to the monitoring indicating the presence of the unmanned aerial vehicle, determining an additional phase delay between the sound as received at the third microphone and the sound as received at one of the first microphone and the second microphone.

It may be that determining the phase delay comprises cross-correlating the sound as received at the first microphone and the sound as received at the second microphone. Similarly, determining the additional phase delay may comprise cross-correlating the sound as received at the third microphone and the sound as received at the one of the first microphone and the second microphone.

A third step, represented by item 705, of the method 700 comprises, on the basis of the determined phase delay and a known separation of the first microphone and the second microphone, determining, at the detector unit, an azimuth angle to the unmanned aerial vehicle from the detector unit.

Where the detector unit comprises a third microphone, the method may comprise, on the basis of the determined additional phase delay and a known separation of the third microphone and the one of the first microphone and the second microphone, determining an elevation angle to the unmanned aerial vehicle from the detector unit.

It may be that determining the azimuth angle from the detector unit to the unmanned aerial vehicle comprises operating a machine learning agent. In such cases, it may be that the machine learning agent is configured to determine the azimuth angle on the basis of the cross-correlation.

A fourth step, represented by item 707, of the method 700 comprises transmitting, to a computing node, the determined azimuth angle for use in determining a location of the unmanned aerial vehicle.

Where the detector unit comprises a third microphone, the method may further comprise transmitting, to the computing node, the determined elevation angle for use in determining a location of the unmanned aerial vehicle.

Alternatively, it may be that the method does not comprise transmitting an elevation angle to the unmanned aerial vehicle from the detector unit.

It may be that the azimuth angle (and/or the elevation angle, where applicable) is transmitted to the computing node using a wireless datalink.

The detector unit and the computing node may be connected by a mesh network. In such cases, it may be that the determined azimuth angle (and/or the elevation angle, where applicable) is transmitted over the mesh network.

It may be that the determined azimuth angle (and/or the elevation angle, where applicable) is transmitted to the computing node via a further detector unit.

An optional fifth step, represented by item 709, of the method 700 comprises, at the computing node, receiving, from the detector unit, the transmitted azimuth angle, and receiving, from a second detector unit, a second azimuth angle to the unmanned aerial vehicle from the second detector unit.

An optional sixth step, represented by item 711, of the method 700 comprises, on the basis of the azimuth angle, the second azimuth angle, and known positions of the detector unit and the second detector unit, determining a ground location of the unmanned aerial vehicle.

Where the detector unit transmits an elevation angle, the method may also comprise receiving, from the detector unit, the transmitted elevation angle. The method may comprise, on the basis of the determined ground position and the received elevation angle, determining a height of the unmanned aerial vehicle.

It may be that determining the location of the unmanned aerial vehicle comprises triangulating its location.

An optional seventh step, represented by arrow 713, of the method 700, comprises, repeating the preceding steps of the method in respect of a further unmanned aerial vehicle.

Thus, the method may comprise, whilst the unmanned aerial vehicle is in the vicinity of the detector unit, monitoring for a further sound associated with the presence of a further unmanned aerial vehicle in the vicinity of the detector unit. Similarly, the method may further comprise, in response to the monitoring indicating the presence of the further unmanned aerial vehicle, determining a further phase delay between the sound as received at the first microphone and the sound as received at the second microphone. The method may further comprise, on the basis of the determined further phase delay and the known separation of the first microphone and the second microphone, determining a further azimuth angle to the further unmanned aerial vehicle from the detector unit. The method may further comprise transmitting, to a computing node, the determined further azimuth angle for use in determining a location of the further unmanned aerial vehicle. The method may further comprise receiving, from the detector unit, the transmitted further azimuth angle. The method may further comprise

receiving, from a further detector unit (for example, the second detector unit or a third detector unit), a further azimuth angle to the unmanned aerial vehicle from the second detector unit. The method may further comprise, on the basis of the further azimuth angle, the second further azimuth angle, and known positions of the detector unit and the further detector unit, determining a ground location of the further unmanned aerial vehicle.

It will be appreciated that, when two UAVs are detected by two detector units, the computing node will receive two azimuth angles from each of those two detector units. Those azimuth angles will intersect at four distinct points, only two of which will correspond to the location of a UAV. Thus, in such cases, it is necessary to identify which two of the four possible locations are correct. Such an identification may be based on known previous locations of the UAVs and predictions of their likely future locations (for example, based on their past locations and movements). Thus, the method may comprise predicting, on the basis of previous motion of the further unmanned aerial vehicle, a future position of the further unmanned aerial vehicle. It may be that the predicting is performed by operating a Kalman filter. The method may comprise, on the basis of the predicted future position, identifying a location (for example, one of a plurality of previously identified possible locations) of the further unmanned aerial vehicle. Thus, the method may comprise determining a plurality of possible ground locations of the further unmanned aerial vehicle. The method may further comprise predicting, on the basis of previous motion of the further unmanned aerial vehicle, a future location of the further unmanned aerial vehicle. The method may further comprise identifying one of the determined plurality of possible ground locations that most closely matches the predicted future location.

An optional eighth step, represented by item 715, of the method 700 comprises, at the computing node, in response to receipt of the azimuth angle, generating an alert indicating that an unmanned aerial vehicle has been detected.

Generating the alert may comprise one or more of, generating an audible noise, lighting a light, and displaying a visual warning on a display associated with the computing node.

An optional ninth step, represented by item 717, of the method 70) comprises, in response to receipt of the azimuth angle, causing action to be taken to impede the operation of the unmanned aerial vehicle.

Impeding the operation of the unmanned aerial vehicle may comprise one or more of, jamming the unmanned aerial vehicle, destroying the unmanned aerial vehicle, physically capturing or trapping the unmanned aerial vehicle, or disabling the unmanned aerial vehicle in any other way.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

Whilst in the described embodiments, the determination of the azimuth angle from the detector unit to the unmanned aerial vehicle is performed by a machine learning agent, other embodiments may instead use conventional signal and/or image processing techniques instead of machine learning (for example, an expert system or hard-coded rule-based classification algorithm).

In the described embodiments, the detector unit is configured to transmit only the determined azimuth angle(s) to the computing node. However, in alternative embodiments, the detector unit is configured to transmit the full set of determined probabilities to the computing node in response to any one of those probabilities exceeding a predetermined threshold. As previously mentioned, transmitting the determined probabilities, where one or more of the determined probabilities exceeds the predetermined threshold and thereby indicates the presence of an unmanned aerial vehicle, is functionally equivalent to transmitting only the azimuth angles corresponding to those notional sectors having probabilities exceeding the predetermined threshold.

Whilst the embodiments described above include only two microphones per sensor pair, it will be appreciated that, in other embodiments of the invention, a single sensor sector may comprise more than two microphones (in which case, they may be referred to as a “sensor group”). For example, a sensor group may comprise four microphones, arranged in two adjacent pairs such that, in use, all four microphones are positioned at substantially the same height. In such cases, the feature extraction module may be configured to perform a cross-correlation for each of the two pairs of adjacent microphones and then combine the outputs of the two cross-correlations (for example, by taking an average), with the combined outputs then being processed by the machine learning agent to determine an azimuth angle to the unmanned aerial vehicle.

Alternatively or additionally, a sensor group may comprise at least a third microphone, the third microphone being positioned at a different height to the first microphone and the second microphone. In such cases, the detector unit may be further configured to determine an additional phase delay between the sound as received at the third microphone and the sound as received at one of the first microphone and the second microphone. It will be appreciated that this further phase delay includes information on the angle of elevation of the detected unmanned aerial vehicle. Thus, in such embodiments, the detector unit may be further configured to determine, on the basis of the further phase delay and a known separation of the third microphone and the one of the first microphone and the second microphone, an elevation angle to the unmanned aerial vehicle from the detector unit. The detector unit may be further configured to transmit the determined elevation angle to the computing node for use in determining a location in 3D space of the unmanned aerial vehicle. In such cases, the computing node may be further configured to, in response to receipt of the elevation angle, determine a height of the unmanned aerial vehicle. It will be appreciated that, once the computing node has determined a ground position of the unmanned aerial vehicle, only a single angle of elevation is further required in order to determine the position of the unmanned aerial vehicle in 3D space.

Whilst in the illustrated embodiments, the detector units are connected to the computing node by a wireless datalink, it will be appreciated that, in other embodiments of the invention, the connection for one, some or all of the detector units may instead be provided by a wired datalink. Suitable techniques and protocols for providing such a wired datalink are well known in the art.

Whilst the embodiments described above illustrate detector units have one, three, and four sensor pairs, it will be appreciated that detector units according to other embodiments of the invention may have other numbers of sensor pairs.

Whilst in the embodiment described above, the computing node comprises a display, on which alerts generated by the target tracking module are displayed, it will be appreciated that other embodiments of the invention may warn a user of the system of an intruding unmanned aerial vehicle by other means. For example, other embodiments of the invention may generate an alert by lighting a warning light, sounding an audible alarm, or by transmitting a signal to a further computing system (for example, a command and control system). In particular, embodiments of the invention may be configured to transmit a signal to a UAV countermeasure control system (either directly or via a further command and control system). In such cases, the UAV countermeasure control system may be configured to, in response to receipt of the signal, deploy one or more UAV countermeasures to impede the operation of the unmanned aerial vehicle (for example, by jamming, destroying, capturing, or otherwise disabling the unmanned aerial vehicle). Thus, computing nodes according to embodiments of invention may be configured to cause action to be taken to impede the operation of the unmanned aerial vehicle.

Although the embodiments above have been described with particular application to the detection of unmanned aerial vehicles, it will be appreciated that the methods, apparatus, and systems of the present invention are also equally applicable to the detection of vehicles of other kinds (for example, manned or unmanned ground vehicles and manned aerial vehicles)

Thus, embodiments of the invention also provide a method of detecting and tracking a vehicle, the method comprising, at a detector unit comprising a first microphone and a second microphone:

monitoring for a sound associated with the presence of the vehicle in the vicinity of the detector unit;

in response to the monitoring indicating the presence of the vehicle, determining, at the detector unit, a phase delay between the sound as received at the first microphone and the sound as received at the second microphone;

on the basis of the determined phase delay and a known separation of the first microphone and the second microphone, determining, at the detector unit, an azimuth angle to the vehicle from the detector unit; and

transmitting, to a computing node, the determined azimuth angle for use in determining a location of the vehicle.

Similarly, embodiments of the invention provide a computer program comprising a set of instructions, which, when executed by a computer, cause the computer to perform such a method.

Embodiments of the invention also provide a detector unit for detecting and tracking a vehicle, the detector unit comprising:

a first microphone;

a second microphone:

a signal processing module configured to:

monitor for a sound associated with the presence of the vehicle in the vicinity of the detector unit,

in response to the monitoring indicating the presence of the vehicle, determine a phase delay between the sound as received at the first microphone and the sound as received at the second microphone, and

on the basis of the determined phase delay and a known separation of the first microphone and the second microphone, determine an azimuth angle to the vehicle from the detector unit; and

a transmitter module configured to transmit, to a computing node, the determined azimuth angle for use in determining a location of the vehicle.

Embodiments of the invention also provide a system for detecting and tracking a vehicle, the system comprising:

a plurality of such detection units; and

a computing node configured to:

receive, from a first detection unit in the plurality, a first azimuth angle from the first detection unit to the vehicle:

receive, from a second detection unit in the plurality, a second azimuth angle from the second detection unit to the vehicle; and

determine, on the basis of the first azimuth angle, the second azimuth angle, and known locations of the first detection unit and the second detection unit, a ground location of the vehicle.

It will be appreciated that the detector unit 100 may comprise one or more processors and/or memory. Thus, in embodiments, the detector unit comprises a processor 219 and an associated memory 221. The processor 219 and the associated memory 221 may be configured to perform one or more of the above-described functions of the detector unit 100. Similarly, the computing node 501 may comprise one or more processors and/or memory. Thus, in embodiments, the computing node 501 comprises a processor 613 and an associated memory 615. The processor 613 and the associated memory 615 may be configured to perform one or more of the above-described functions of the computing node 501. Each device, module, component, machine or function as described in relation to any of the examples described herein (for example, Fourier transform module 206, feature extraction module 207, machine learning agent 211, transceiver 215, transceiver 603, or target tracking module 607) may similarly comprise a processor or may be comprised in apparatus comprising a processor. One or more aspects of the embodiments described herein comprise processes performed by apparatus. In some examples, the apparatus comprises one or more processors configured to carry out these processes. In this regard, embodiments may be implemented at least in part by computer software stored in (non-transitory) memory and executable by the processor, or by hardware, or by a combination of tangibly stored software and hardware (and tangibly stored firmware). Embodiments also include computer programs, particularly computer programs on or in a carrier, adapted for putting the above-described embodiments into practice. The program may be in the form of non-transitory source code, object code, or in any other non-transitory form suitable for use in the implementation of processes according to embodiments. The carrier may be any entity or device capable of carrying the program, such as a RAM, a ROM, or an optical memory device, etc.

The one or more processors of the detector unit 100 and/or the computing node 501 may comprise a central processing unit (CPU). The one or more processors may comprise a graphics processing unit (GPU). The one or more processors may comprise one or more of a field programmable gate array (FPGA), a programmable logic device (PLD), or a complex programmable logic device (CPLD). The one or more processors may comprise an application specific integrated circuit (ASIC). It will be appreciated by the skilled person that many other types of device, in addition to the examples provided, may be used to provide the one or more processors. The one or more processors may comprise multiple co-located processors or multiple disparately located processors. Operations performed by the one or more processors may be carried out by one or more of hardware, firmware, and software.

The one or more processors may comprise data storage. The data storage may comprise one or both of volatile and non-volatile memory. The data storage may comprise one or more of random access memory (RAM), read-only memory (ROM), a magnetic or optical disk and disk drive, or a solid-state drive (SSD). It will be appreciated by the skilled person that many other types of memory, in addition to the examples provided, may also be used. It will be appreciated by a person skilled in the art that the one or more processors may each comprise more, fewer and/or different components from those described.

The techniques described herein may be implemented in sofhware or hardware, or may be implemented using a combination of software and hardware. They may include configuring an apparatus to carry out and/or support any or all of techniques described herein. Although at least some aspects of the examples described herein with reference to the drawings comprise computer processes performed in processing systems or processors, examples described herein also extend to computer programs, for example computer programs on or in a carrier, adapted for putting the examples into practice. The carrier may be any entity or device capable of carrying the program. The carrier may comprise a computer readable storage media. Examples of tangible computer-readable storage media include, but are not limited to, an optical medium (e.g., CD-ROM, DVD-ROM or Blu-ray), flash memory card, floppy or hard disk or any other medium capable of storing computer-readable instructions such as firmware or microcode in at least one ROM or RAM or Programmable ROM (PROM) chips.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of detecting and tracking an unmanned aerial vehicle, the method comprising, at a detector unit comprising a first microphone and a second microphone:
monitoring for a sound associated with the presence of the unmanned aerial vehicle in the vicinity of the detector unit;
in response to the monitoring indicating the presence of the unmanned aerial vehicle, determining, at the detector unit, a phase delay between the sound as received at the first microphone and the sound as received at the second microphone;
on the basis of the determined phase delay and a known separation of the first microphone and the second microphone, determining, at the detector unit, an azimuth angle to the unmanned aerial vehicle from the detector unit; and
transmitting, to a computing node, the determined azimuth angle for use in determining a location of the unmanned aerial vehicle.

2. A method according to claim 1, further comprising, at the computing node:
receiving, from the detector unit, the transmitted azimuth angle;
receiving, from a second detector unit, a second azimuth angle to the unmanned aerial vehicle from the second detector unit;
on the basis of the azimuth angle, the second azimuth angle, and known positions of the detector unit and the second detector unit, determining a ground location of the unmanned aerial vehicle.

3. A method according to claim 2, wherein determining the location of the unmanned aerial vehicle comprises triangulating its location.

4. A method according to claim 1, wherein the method does not comprise transmitting an elevation angle.

5. A method according to claim 1, further comprising, whilst the unmanned aerial vehicle is in the vicinity of the detector unit:
monitoring for a further sound associated with the presence of a further unmanned aerial vehicle in the vicinity of the detector unit;
in response to the monitoring indicating the presence of the further unmanned aerial vehicle, determining a further phase delay between the sound as received at the first microphone and the sound as received at the second microphone;
on the basis of the determined further phase delay and the known separation of the first microphone and the second microphone, determining a further azimuth angle to the further unmanned aerial vehicle from the detector unit; and
transmitting, to the computing node, the determined further azimuth angle for use in determining a location of the further unmanned aerial vehicle.

6. A method according to claim 5, further comprising:
receiving, from the detector unit, the transmitted further azimuth angle;
receiving, from a further detector unit, a further azimuth angle to the unmanned aerial vehicle from the second detector unit;
on the basis of the further azimuth angle, the second further azimuth angle, and known positions of the detector unit and the further detector unit, determining a ground location of the further unmanned aerial vehicle.

7. A method according to claim 6, wherein determining a ground location of the further unmanned aerial vehicle comprises:
determining a plurality of possible ground locations of the further unmanned aerial vehicle;
predicting, on the basis of previous motion of the further unmanned aerial vehicle, a future location of the further unmanned aerial vehicle; and
identifying one of the determined plurality of possible ground locations that most closely matches the predicted future location.

8. A method according to claim 1, wherein the azimuth angle is transmitted to the computing node using a wireless datalink.

9. A method according to claim 1, wherein:
the detector unit and the computing node are connected by a mesh network; and
the determined azimuth angle is transmitted over the mesh network.

10. A method according to claim 1, wherein the determined azimuth angle is transmitted to the computing node via a further detector unit.

11. A method according to claim 1, wherein determining the phase delay comprises cross-correlating the sound as received at the first microphone and the sound as received at the second microphone.

12. A method according to claim 1, wherein determining the azimuth angle from the detector unit to the unmanned aerial vehicle comprises operating a machine learning agent.

13. A method according to claim 12, wherein:
determining the phase delay comprises cross-correlating the sound as received at the first microphone and the sound as received at the second microphone; and
the machine learning agent is configured to determine the azimuth angle on the basis of the cross-correlation.

14. A method according to claim 1, further comprising, at the computing node, in response to receipt of the azimuth angle, generating an alert indicating that an unmanned aerial vehicle has been detected.

15. A computer program comprising a set of instructions, which, when executed by a computer, cause the computer to perform a method according to claim 1.

16. A detector unit for detecting and tracking an unmanned aerial vehicle, the detector unit comprising:
a first microphone;
a second microphone;
a signal processing module configured to:
monitor for a sound associated with the presence of the unmanned aerial vehicle in the vicinity of the detector unit,
in response to the monitoring indicating the presence of the unmanned aerial vehicle, determine a phase delay between the sound as received at the first microphone and the sound as received at the second microphone, and
on the basis of the determined phase delay and a known separation of the first microphone and the second microphone, determine an azimuth angle to the unmanned aerial vehicle from the detector unit; and
a transmitter module configured to transmit, to a computing node, the determined azimuth angle for use in determining a location of the unmanned aerial vehicle.

17. A detector unit according to claim 16, wherein:
the first microphone and the second microphone together comprise a sensor pair having a field of view of less than 180°; and
the detector unit comprises a further sensor pair, arranged such that the sensor pair and the further sensor pair together provide a field of view of greater than 180°.

18. A detector unit according to claim 17, wherein the detector unit comprises three or more sensor pairs arranged to together provide a 3600 field of view.

19. A detector unit according to claim 16, wherein the first microphone and the second microphone are arranged such that, in use, they are positioned at substantially the same height.

20. A system for detecting and tracking an unmanned aerial vehicle, the system comprising:
a plurality of detection units according to claim 16; and
a computing node configured to:
receive, from a first detection unit in the plurality, a first azimuth angle from the first detection unit to the unmanned aerial vehicle;
receive, from a second detection unit in the plurality, a second azimuth angle from the second detection unit to the unmanned aerial vehicle; and
determine, on the basis of the first azimuth angle, the second azimuth angle, and known locations of the first detection unit and the second detection unit, a ground location of the unmanned aerial vehicle.
